(19) United States
(12) Patent Application Publication
(10) Pub. No.: US 2013/0297311 A1
(43) Pub. Date: Nov. 7, 2013

(54) INFORMATION PROCESSING APPARATUS, INFORMATION PROCESSING METHOD AND INFORMATION PROCESSING PROGRAM

(71) Applicant: SONY CORPORATION, Tokyo (JP)

(72) Inventors: Takeshi Yamaguchi, Kanagawa (JP); Yasuhiko Kato, Kanagawa (JP); Nobuyuki Kihara, Tokyo (JP); Yohei Sakuraba, Kanagawa (JP)

(73) Assignee: Sony Corporation, Tokyo (JP)

(21) Appl. No.: 13/838,999

(22) Filed: Mar. 15, 2013

(30) Foreign Application Priority Data
May 7, 2012 (JP) 2012-105948

(51) Int. Cl. G10L 15/22

(52) U.S. Cl. CPC G10L 15/22
USPC 704/250

(57) ABSTRACT

An information processing apparatus including: a high-quality-voice determining section configured to determine a voice, which can be determined to have been collected under a good condition, as a good-condition voice included in mixed voices pertaining to a group of voices collected under different conditions; and a voice recognizing section configured to carry out voice recognition processing by making use of a predetermined parameter on the good-condition voice determined by the high-quality-voice determining section, modify the value of the predetermined parameter on the basis of a result of the voice recognition processing carried out on the good-condition voice, and carry out the voice recognition processing by making use of the predetermined parameter having the modified value on a voice included in the mixed voices as a voice other than the good-condition voice.

### BACKGROUND

In general, the present technology relates to an information processing apparatus, an information processing method and an information processing program. More particularly, the present technology relates to an information processing apparatus capable of improving precision of voice recognition for a group of voices collected under different voice collection conditions, relates to an information processing method provided for the information processing apparatus and relates to an information processing program implementing the information processing method.

In the past, voices output by conference participants in a conference room were recorded by making use of a voice recorder or the like and, in addition, voices output by TV (television)-conference participants are transmitted and received by the participants after being coded and decoded. Thus, in such conferences, there are voice recording systems also referred to hereafter as voice collecting systems. As technologies of related art for applying a voice recognition technique to such a voice collecting system, there are provided a technology for automatically created conference minutes and a technology for detecting improper statements in order to prevent the voices of the statements from being transmitted. For more information on the technology for automatically created conference minutes, refer to Japanese Patent Laid-open Nos. 2004-287201 and 2003-255979 (hereinafter referred to as Patent Documents 1 and 2, respectively). For more information on the technology for detecting improper statements, on the other hand, refer to Japanese Patent Laid-open No. 2011-205243 (hereinafter referred to as Patent Document 3).

### SUMMARY

When voices output by a plurality of conference participants in a conference room are recorded by making use of a voice recorder or the like, however, the voices generally propagate from the participants to the mike of the recorder through different distances in many cases. In addition, in some cases, the audio codec used for coding and decoding voices output by TV-conference participants in any specific conference room differs from that used for coding and decoding voices output by TV-conference participants in another conference room connected to the specific conference room in a TV conference. As described above, in many cases, voice colleting systems have different voice collection conditions.

In the voice recognition technologies of related art including those disclosed in Patent Documents 1 to 3, for a group of voices collected under different voice collection conditions, voice recognition processing is carried out in a single uniform way. In this case, group voices collected under a good condition can be recognized with a high degree of precision. It is feared, however, that other voices cannot be recognized with a high degree of precision in some cases.

It is thus desired for the present technology to address the problems described above to improve precision of voice recognition for a group of voices collected under different voice collection conditions.

An information processing apparatus according to an embodiment of the present technology includes:

a high-quality-voice determining section configured to determine a voice, which can be determined to have been collected under a good condition, as a good-condition voice included in mixed voices pertaining to a group of voices collected under different conditions; and

a voice recognizing section configured to

carry out voice recognition processing by making use of a predetermined parameter on the good-condition voice determined by the high-quality-voice determining section;

modify the value of the predetermined parameter on the basis of a result of the voice recognition processing carried out on the good-condition voice; and

carry out the voice recognition processing by making use of the predetermined parameter having the modified value on a voice included in the mixed voices as a voice other than the good-condition voice.

The high-quality-voice determining section is capable of segmentalizing the mixed voices into voice outputting periods, computing an S/N ratio for each of the voice outputting periods and determining the good-condition voice for each of the voice outputting periods on the basis of the computed S/N ratios.

The high-quality-voice determining section is capable of segmentalizing the mixed voices into voice outputting periods, computing an S/N ratio for each of the voice outputting periods and determining the good-condition voice for each of voice outputting persons on the basis of the computed S/N ratios.

The mixed voices include a plurality of voices resulting from processing carried out by each of a plurality of audio codecs and, in a process to determine the good-condition voice, the high-quality-voice determining section is capable of determining a voice resulting from processing carried out by an audio codec as a voice having a high quality in comparison with the voices resulting from the processing carried out by each of the other audio codecs.

The voice recognizing section includes:

a feature-quantity extracting block configured to extract a feature quantity from a processing object included in the mixed voices;

a likelihood computing block configured to generate a plurality of candidates for a voice recognition processing result for the processing object and compute a likelihood for each of the candidates on the basis of a feature quantity extracted by the feature-quantity extracting block;

a comparison block configured to compare each of the likelihoods each computed by the likelihood computing block for one of the candidates with a predetermined threshold value, to select a voice recognition processing result for the processing object from the candidates on the basis of a result of the comparison and to output the selected voice recognition processing result; and

a parameter modifying block configured to modify a parameter used in at least one of the feature-quantity extracting block, the likelihood computing block and the comparison block as the predetermined parameter on the basis of the voice recognition processing result output by the comparison block when the good-condition voice has been set to serve as the processing object.

If a voice other than the good-condition voice has been set to serve as the processing object, the parameter modifying block is capable of modifying a prior probability, which is used by the likelihood computing block in computation of a likelihood, as the predetermined parameter for a candidate including a word included in a voice recognition processing result for the good-condition voice.

If a voice other than the good-condition voice has been set to serve as the processing object, the parameter modifying block is capable of modifying the threshold value, which is used in the comparison block, as the predetermined parameter.

If a voice other than the good-condition voice has been set to serve as the processing object, the parameter modifying block is capable of modifying a prior probability, which is used by the likelihood computing block in computation of a likelihood, as the predetermined parameter for a candidate including a related word of a word included in a voice recognition processing result for the good-condition voice.

If a voice other than the good-condition voice has been set to serve as the processing object, the parameter modifying block is capable of modifying a frequency analysis technique, which is adopted in the feature-quantity extracting block to extract a feature quantity, as the predetermined parameter.

If a voice other than the good-condition voice has been set to serve as the processing object, the parameter modifying block is capable of modifying the type of a feature quantity, which is extracted by the feature-quantity extracting block, as the predetermined parameter.

If a voice other than the good-condition voice has been set to serve as the processing object, the parameter modifying block is capable of modifying the number of candidates which are used in the likelihood computing block, as the predetermined parameter.

The parameter modifying block is capable of setting a predetermined number of time units before and after the good-condition voice to serve as a modification time range for the predetermined parameter and capable of uniformly modifying the value of the predetermined parameter for a voice output at a time included in the modification time range.

The parameter modifying block is capable of setting a predetermined number of time units before and after the good-condition voice to serve as a modification time range for the predetermined parameter and capable of modifying the value of the predetermined parameter for a voice output at a time included in the modification time range in accordance with a time distance from the good-condition voice to the voice output at the time included in the modification time range.

The parameter modifying block is capable of setting a predetermined number of voice outputting periods before and after the good-condition voice to serve as a modification time range for the predetermined parameter and capable of uniformly modifying the value of the predetermined parameter for a voice output at a time included in the modification time range.

The parameter modifying block is capable of setting a predetermined number of voice outputting periods before and after the good-condition voice to serve as a modification time range for the predetermined parameter. In addition, a sequence number counted from the voice outputting period immediately before the good-condition voice is assigned to each of the voice outputting periods before the good-condition voice whereas a sequence number counted from the voice outputting period immediately after the good-condition voice is assigned to each of the voice outputting periods after the good-condition voice. On top of that, for a voice outputting period included in the modification time range, the parameter modifying block is capable of modifying the value of the predetermined parameter in accordance with the sequence number assigned to the voice outputting period.

An information processing method according to an embodiment of the present technology is a method provided for the information processing apparatus whereas an information processing program according to an embodiment of the present technology is a program implementing the method.

In the information processing method according to the embodiment of the present technology and the information processing program according to the embodiment of the present technology, information processing is carried out as follows. First of all, a voice which can be determined to have been collected under a good condition is determined as a good-condition voice included in mixed voices pertaining to a group of mixed voices collected under different conditions. Then, voice recognition processing is carried out by making use of a predetermined parameter on the determined good-condition voice. Subsequently, the value of the predetermined parameter is modified on the basis of a result of the voice recognition processing carried out on the good-condition voice. Finally, the voice recognition processing is carried out by making use of the predetermined parameter having the modified value on a voice included in the mixed voices as a voice other than the good-condition voice.

As described above, by virtue of the present technology, it is possible to improve precision of voice recognition for a group of voices collected under different voice collection conditions.

### BRIEF DESCRIPTION OF THE DRAWINGS

FIG. 1 is a block diagram showing a typical configuration of a voice recognizing apparatus;

FIG. 2 is a diagram to be referred to in explanation of a high-quality-voice determination technique adopted by a high-quality-voice determining section;

FIG. 3 is a diagram to be referred to in explanation of a voice recognition technique adopted by a voice recognizing section;

FIG. 4 is a flowchart to be referred to in explanation of a typical flow of mixed-voice recognition processing;

FIG. 5 is a flowchart to be referred to in explanation of a typical detailed flow of voice recognition processing carried out on a processing object; and

FIG. 6 is a block diagram showing a typical configuration of hardware employed in a signal processing apparatus according to the present technology.

### DETAILED DESCRIPTION OF THE PREFERRED EMBODIMENTS

### Outline of the Technology

First of all, in order to make the present technology easy to understand, the outline of the present technology is explained as follows.

By virtue of the present technology, it is possible to collect a group of voices by making use of any one of a variety of voice collecting systems under different conditions.

For example, in a voice collecting system for recording voices output by a plurality of conference participants in a conference room by making use of a voice recorder or the like, each of the participants speaks in a condition different from those of the other participants. The conditions include the voice loudness, the voice quality and the distance between the conference participant and the mike. Thus, voices output by such conference participants are collected under different voice collection conditions.

In addition, in a voice collecting system for a TV conference, voices output by a conference participant in a conference room are transmitted to another conference room. Thus, for every conference room, it is necessary to provide an audio codec for coding and decoding voices. If the audio codec differs from conference room to conference room, voices are collected under different voice collection conditions.

As described above, in the present technology, if voices are collected under different voice collection conditions, a group of voices collected under different voice collection conditions serves as a processing object subjected to voice recognition processing. In the following description, voices composing such a group are referred to as mixed voices.

To put it concretely, in the present technology, first of all, a good-condition voice is determined from the mixed voices. A good-condition voice is a voice which can be determined to be a voice collected under a good voice collection condition. Then, the voice recognition processing is carried out on the good-condition voice and the value of a parameter used in the voice recognition processing is modified on the basis of a result of the voice recognition processing carried out on the good-condition voice. Finally, the voice recognition processing is carried out on a voice other than the good-condition voice by making use of the parameter with a modified value.

Thus, it is possible to improve the precision of the voice recognition processing carried out on the voices other than the good-condition voice. As a result, it is possible to uniformly improve the precision of the voice recognition processing carried out on all voices.

### Typical Configuration of the Voice Recognizing Apparatus

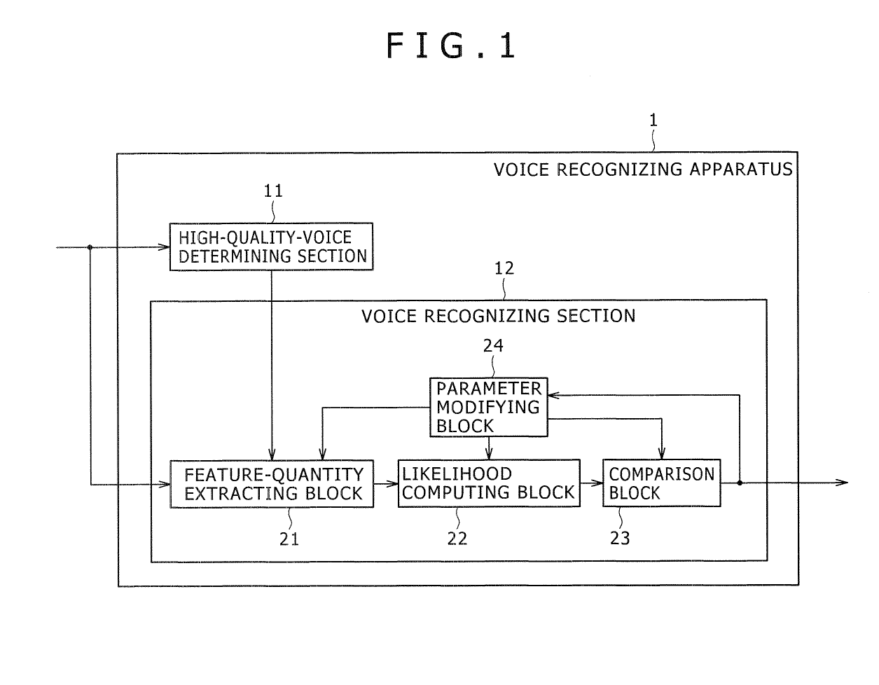

FIG. 1 is a block diagram showing a typical configuration of a voice recognizing apparatus to which an embodiment of the present technology is applied.

As shown in the figure, the voice recognizing apparatus 1 includes a high-quality-voice determining section 11 and a voice recognizing section 12.

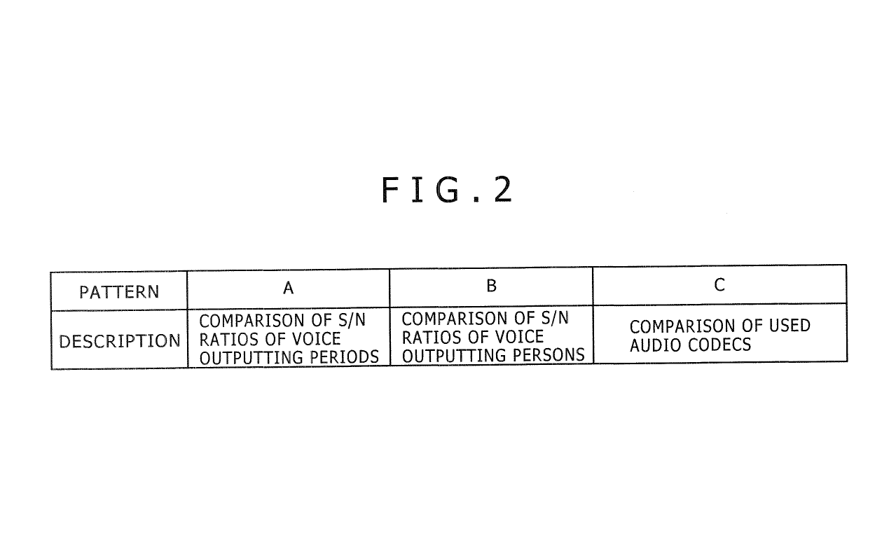

The high-quality-voice determining section 11 analyzes mixed voices received by the voice recognizing apparatus 1 in order to determine a good-condition voice included in the mixed voices and supplies the result of the determination to the voice recognizing section 12. It is to be noted that a technique adopted by the high-quality-voice determining section 11 to determine a good-condition voice will be explained later by referring to FIG. 2.

First of all, on the basis of the determination result received from the high-quality-voice determining section 11, the voice recognizing section 12 handles the good-condition voice included in the mixed voices received by the voice recognizing apparatus 1 as a processing object and carries out voice recognition processing on the processing object by making use of a parameter determined in advance. Then, the voice recognizing section 12 modifies the value of the predetermined parameter on the basis of the result of the voice recognition processing carried out on the good-condition voice. Subsequently, the voice recognizing section 12 handles a voice, which is included in the mixed voices received by the voice recognizing apparatus 1 as a voice other than the good-condition voice, as a processing object. Finally, the voice recognizing section 12 carries out the voice recognition processing on the other voice serving as the processing object by making use of the predetermined parameter whose value has been modified.

The voice recognition processing carried out by the voice recognizing section 12 is processing to find a word column W′ as the result of the processing (that is, as an inference result of a word column W). The word column W′ is a word column having the greatest posterior probability p (W=X) for a feature quantity X of the input voice (that is, for the processing object) for the word column W. Since it is difficult for the voice recognizing section 12 to directly find the posterior probability p (W=X), however, the result of the voice recognition processing is computed by making use of a likelihood and a prior probability in accordance with a Bayesian law. Thus, the voice recognizing section 12 is configured to include a feature-quantity extracting block 21, a likelihood computing block 22, a comparison block 23 and a parameter modifying block 24 which are used for carrying out such voice recognition processing.

On the basis of the determination result produced by the high-quality-voice determining section 11, the feature-quantity extracting block 21 determines a voice to be used as a processing object from mixed voices received by the voice recognizing apparatus 1. That is to say, as described earlier, the feature-quantity extracting block 21 initially determines the good-condition voice as the processing object. Then, after the value of the parameter has been modified, the feature-quantity extracting block 21 determines a voice other than the good-condition voice as the processing object. Subsequently, the feature-quantity extracting block 21 extracts a feature quantity from the processing object for every predetermined unit such as a frame.

That is to say, the feature-quantity extracting block 21 carries out an acoustic treatment such as FFT (Fast Fourier Transform) processing for every predetermined unit in order to sequentially extract feature quantities of typically MFCCs (Mel Frequency Cepstrum Coefficients) and supplies a time-axis series of the feature quantities to the likelihood computing block 22. It is to be noted that, as the feature quantities, the feature-quantity extracting block 21 may extract quantities other than the MFCCs. Typical examples of the quantities other than the MFCCs are a spectrum, linear predictive coefficients, cepstrum coefficients and a line spectral pair, to mention a few.

The likelihood computing block 22 generates a plurality of groups obtained by concatenating acoustic models such as HMMs (Hidden Markov Models) in word units as candidates for a recognition result. In the following description, the group is referred to as a word model group. Then, for every plurality of word model groups, the likelihood computing block 22 makes use of a prior probability as one of parameters in order to compute a likelihood that the time-axis series of processing-object feature quantities received from the feature-quantity extracting block 21 is observed.

The comparison block 23 compares the likelihood computed by the likelihood computing block 22 for every plurality of word model groups with a threshold value determined in advance and outputs a word model group having a likelihood greater than the predetermined threshold value to serve as a result of the voice recognition processing carried out on the processing object.

The parameter modifying block 24 changes the value of a parameter used by at least one of the feature-quantity extracting block 21, the likelihood computing block 22 and the comparison block 23 on the basis of the voice recognition processing result output by the comparison block 23 for a case in which the good-condition voice is taken as the processing object.

Thus, when a voice other than the good-condition voice is taken as the processing object, the sequence of processes described above is carried out by the feature-quantity extracting block 21, the likelihood computing block 22 and the comparison block 23 by making use of, among others, a parameter, the value of which has been modified by the parameter modifying block 24, in order to perform the voice recognition processing on the processing object.

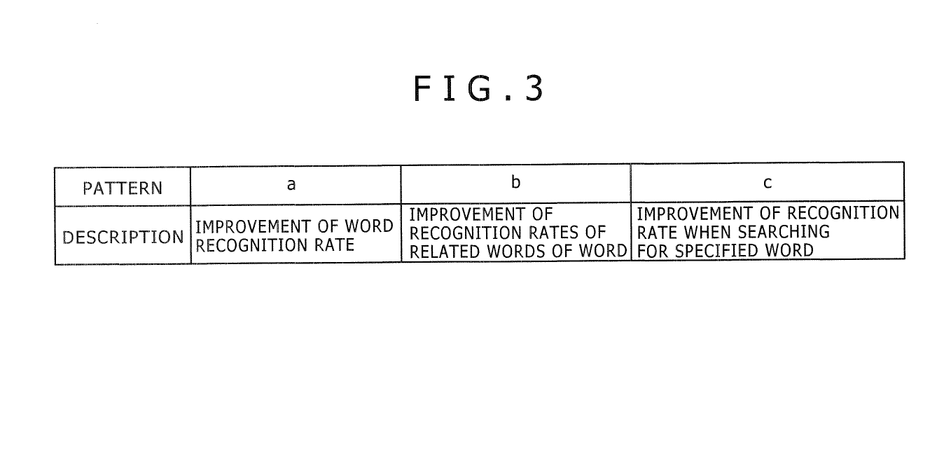

It is to be noted that, by referring to FIG. 3, a later description will explain, among others, concrete examples of a parameter that needs to be modified and explain a voice recognition technique adopted by the voice recognizing section 12.

### Technique for Determining a Voice Having a High Quality

FIG. 2 is a diagram referred to in the following explanation of a high-quality-voice determination technique adopted by the high-quality-voice determining section 11.

The high-quality-voice determining section 11 determines a good-condition voice included in mixed voices by adoption of three techniques, that is, techniques of patterns A, B and C respectively which are shown in FIG. 2. In the following description, the techniques of patterns A, B and C are referred to as an A-pattern technique, a B-pattern technique and a C-pattern technique respectively.

The A-pattern technique is a technique of comparing the S/N (Signal to Noise) ratios of voice outputting periods. To put it concretely, the high-quality-voice determining section 11 segmentalizes the mixed voices into voice outputting periods and computes an S/N ratio for each of the voice outputting periods obtained as a result of the segmentalization. Then, on the basis of the computed S/N ratios, the high-quality-voice determining section 11 determines the voice of the voice outputting period having a high S/N ratio as the good-condition voice.

The B-pattern technique is also a technique of comparing the S/N ratios of voice outputting periods but is different from the A-pattern technique. To put it concretely, the high-quality-voice determining section 11 segmentalizes the mixed voices into voice outputting periods and computes an S/N ratio for each of the voice outputting periods in the same way as the A-pattern technique. Then, the high-quality-voice determining section 11 recognizes voice outputting persons in every voice outputting period of the mixed voices and groups the mixed voices for each of the voice outputting persons. Subsequently, by carrying out processes including collection of the computed S/N ratios for each voice outputting person in every voice outputting period of the mixed voices, the high-quality-voice determining section 11 determines the voice of the voice outputting person having a high S/N ratio as the good-condition voice.

It is to be noted that the technique for recognizing a voice outputting person is not prescribed in particular. If the feature quantity is extracted from the frequency of a voice for example, it is possible to adopt a technique for recognizing a voice outputting person on the basis of the feature quantity. In addition, the technique for computing an S/N ratio for every voice outputting person is also not prescribed in particular. For example, it is possible to adopt a technique in which, for all voice outputting periods of a voice outputting person, the S/N ratios computed for the voice outputting person are simply summed up in cumulative addition to result in a sum for the voice outputting person and the sum is then divided by the number of voice outputting periods of the voice outputting person in order to give the S/N ratio per voice outputting period for the voice outputting person.

The C-pattern technique is a technique of comparing used audio codecs. In a TV conference system, terminals used on both sides and audio codecs used in the terminals may be different from each other in some cases. In such cases, results of processing carried out by the audio codecs may cause differences in voice quality. In order to solve this problem, the high-quality-voice determining section 11 obtains information on the audio codecs employed in terminals used on both sides in advance and determines a voice generated by a terminal employing an audio codec outputting a voice with a higher quality as a good-condition voice. In the case of this technique, audio codecs outputting voices with higher qualities are ranked in advance.

It is to be noted that the C-pattern technique is not adopted for a case in which no audio codec is used. A typical example of the case is voice collection making use of a voice recorder.

### Voice Recognition Technique

Next, a voice recognition technique adopted by the voice recognizing section 12 is described by referring to FIG. 3 as follows.

FIG. 3 is a diagram referred to in the following explanation of a voice recognition technique adopted by the voice recognizing section 12.

The voice recognizing section 12 carries out voice recognition processing on a processing object by adoption of three techniques, that is, techniques of patterns a, b and c respectively which are shown in FIG. 3. In the following description, the techniques of patterns a, b and c are referred to as an a-pattern technique, a b-pattern technique and a c-pattern technique respectively.

The a-pattern technique is a technique of raising a recognition rate of a word.

To put it concretely, first of all, the feature-quantity extracting block 21, the likelihood computing block 22 and the comparison block 23 carry out voice recognition processing on a good-condition voice and a word model group determined in advance is output as a result of the voice recognition processing. The probability that a word included in the predetermined word model group output as a result of the voice recognition processing carried out on the good-condition voice also appears in voices other than the good-condition voice and, particularly, in voices output before and after the good-condition voice is assumed to be high. It is to be noted that, in the following description, the technical term “before the good-condition voice” implies a time range leading ahead of the head position of the good-condition voice on the time axis. On the other hand, the technical term “after the good-condition voice” implies a time range lagging behind the tail position of the good-condition voice on the time axis. Thus, the parameter modifying block 24 modifies the value of a parameter used in the likelihood computing block 22 or the comparison block 23 so that, in the voice recognition processing taking a voice output before or after the good-condition voice as the processing object, the word is more easily output by being included in the result of the voice recognition processing. That is to say, the parameter modifying block 24 modifies the value of the parameter so as to improve the recognition rate.

To put it concretely, if a voice output before or after the good-condition voice is taken as the processing object, the parameter modifying block 24 changes a prior probability used by the likelihood computing block 22 to compute a likelihood for the word model group including the word. Thus, the likelihood for the word becomes easy to increase to a high value. As a result, from the comparison block 23 at a later stage, the word becomes more easily selectable as a portion of the result of the voice recognition processing. That is to say, the word becomes easy to recognize.

In addition, if a voice output before or after the good-condition voice is taken as the processing object, the parameter modifying block 24 changes a threshold value used by the comparison block 23. As described before, the parameter modifying block 24 compares the likelihood received from the likelihood computing block 22 with the threshold value determined in advance. A word model group with a likelihood equal to or smaller than the threshold value determined in advance is considered to be not a word model group indicated by a voice included in the mixed voices to serve as the processing object. A word model group with such a likelihood is rejected. Even in such a case, for example, the parameter modifying block 24 decreases the threshold value to a low value which makes the word model group difficult to reject. Thus, the word model group is hardly rejected. As a result, the word included in the word model group serving as a processing object becomes easy to select as a portion of the result of the voice recognition processing. That is to say, the processing object is recognized.

The b-pattern technique is a technique of improving the recognition rate of related words of a recognized word.

To put it concretely, a word-set list is created and stored in a memory in advance. The word-set list is a list showing a plurality of word sets each composed of a recognized word and related words of the recognized word. The word-set list can be created by the user manually or the voice recognizing apparatus 1 automatically. It is to be noted that the technique adopted by the voice recognizing apparatus 1 to create a word-set list is not prescribed in particular. In the case of this embodiment for example, a word-set list is created by analyzing conference minutes already stored in a memory. Let the word “feature quantity” be taken as an example. The word “extract” is a related word of the word “feature quantity” and the probability that the related word “extract” appears at a location close to the word “feature quantity” is high. In this case, a word set composed of the word “feature quantity” and the word “extract” is included on the word-set list. Let the word “screen” be taken as another example. The word “monitor” is a related word which has a meaning similar to the meaning of the word “screen.” In this case, a word set composed of the word “screen” and the word “monitor” is included on the word-set list.

With such a word-set list existing, the feature-quantity extracting block 21, the likelihood computing block 22 and the comparison block 23 carry out voice recognition processing on a good-condition voice and a word model group determined in advance is output as a result of the voice recognition processing. The probability that a related word of a word included in the predetermined word model group output as a result of the voice recognition processing carried out on the good-condition voice also appears in voices other than the good-condition voice and, particularly, in voices output before and after the good-condition voice is assumed to be high. Thus, the parameter modifying block 24 modifies the value of a parameter used in the likelihood computing block 22 or the comparison block 23 so that, in the voice recognition processing taking a voice output before or after the good-condition voice as the processing object, the related word is more easily output by being included in the result of the voice recognition processing. That is to say, the parameter modifying block 24 modifies the value of the parameter so as to improve the recognition rate.

To put it concretely, if a voice output before or after the good-condition voice is taken as the processing object, the parameter modifying block 24 changes a prior probability used by the likelihood computing block 22 to compute a likelihood for the related word of the word included in the word model group. Thus, the likelihood for the related word becomes easy to increase to a high value. As a result, from the comparison block 23 at a later stage, the related word becomes more easily selectable as a portion of the result of the voice recognition processing. That is to say, the related word becomes easy to recognize.

In addition, if a voice output before and after the good-condition voice is taken as the processing object, the parameter modifying block 24 changes a threshold value used by the comparison block 23. As described before, the parameter modifying block 24 compares the likelihood received from the likelihood computing block 22 with the threshold value determined in advance. A word model group with a likelihood equal to or smaller than the threshold value determined in advance is considered to be not a word model group indicated by a voice included in the mixed voices to serve as the processing object. A word model group with such a likelihood is rejected. Even in such a case, for example, the parameter modifying block 24 decreases the threshold value to a low value which makes the word model group difficult to reject. Thus, the word model group is hardly rejected. As a result, the related word included in the word model group serving as a processing object becomes easy to select as a portion of the result of the voice recognition processing. That is to say, the processing object is recognized.

The c-pattern technique is a technique of improving the recognition rate of a specified word if the voice recognition processing is carried out to search for the word.

The c-pattern technique is adopted to search mixed words for a specified word. To put it concretely, in processing to search mixed words for a specified word, if the specified word is recognized from the good-condition voice, the probability that the specified word also appears in voices output before and after the good-condition voice is assumed to be high. Thus, the parameter modifying block 24 modifies the value of a parameter used in the feature-quantity extracting block 21 or the likelihood computing block 22 so that the specified word can be searched for with a high degree of precision.

To put it concretely, when the voices output before and after the good-condition voice are searched for a specified word, the parameter modifying block 24 changes a frequency analysis technique adopted in acoustic processing carried out by the feature-quantity extracting block 21. For example, the parameter modifying block 24 changes a window size and/or a shift size in FFT processing carried out by the feature-quantity extracting block 21 as a kind of acoustic processing.

If the window size is increased for example, the frequency resolution can be increased. If the window size is decreased, on the other hand, the time resolution can be increased. In addition, if the shift size is increased, more frames can be analyzed. By properly changing the window size and/or the shift size in this way, the voices output before and after the good-condition voice can also be searched for a specified word with a high degree of precision.

In addition, if the voices output before and after the good-condition voice are searched for a specified word, the parameter modifying block 24 may increase the number of types of the feature quantity to be extracted by the feature-quantity extracting block 21. By increasing the number of types of the feature quantity to be used, a high likelihood is computed in processing carried out by the likelihood computing block 22 at a later stage. Thus, the voices output before and after the good-condition voice can also be searched for a specified word with a high degree of precision.

It is to be noted that, if the parameter modifying block 24 takes a parameter used by the feature-quantity extracting block 21 as an object to be changed, it is feared that the amount of computation carried out by the voice recognizing section 12 increases. In this embodiment, however, the processing object of the voice recognition processing making use of a modified parameter is limited to the voices output before and after the good-condition voice. Thus, the increase of the amount of computation carried out by the voice recognizing section 12 can be minimized.

In addition, the parameter modifying block 24 increases the number of acoustic models used by the likelihood computing block 22. By increasing the number of acoustic models used by the likelihood computing block 22, it is possible to raise the number of candidates for the recognition result and enhance the recognition performances of the likelihood computing block 22 and the comparison block 23 provided at a later stage. Thus, specified word is searched for with a high degree of precision. It is to be noted that, by increasing the number of acoustic models used by the likelihood computing block 22, the amount of computation carried out by the parameter modifying block 24 and the like rises. Thus, it is nice to increase the number of acoustic models used by the likelihood computing block 22 to a value that needs to be properly adjusted in advance.

As described above, in the voice recognizing apparatus 1 according to this embodiment, the high-quality-voice determining section 11 adopts three high-quality-voice determination techniques whereas the voice recognizing section 12 adopts three voice recognition techniques. Thus, the voice recognizing apparatus 1 according to this embodiment carries out the voice recognition processing by adoption of a total of nine combination techniques.

The above description has explained the a-pattern, b-pattern and c-pattern techniques adopted by the voice recognizing section 12 as the three voice recognition techniques. In the implementation of the a-pattern, pattern and c-pattern techniques adopted by the voice recognizing section 12 as the three voice recognition techniques, the parameter modifying block 24 adopts four pattern techniques as parameter modification techniques described as follows.

In accordance with the first pattern parameter modification technique, from the beginning, the parameter modifying block 24 sets a parameter modification time range of up to n seconds before the good-condition voice and up to n seconds after the good-condition voice. In this case, n is any integer. The parameter modifying block 24 then sets a changed value of a parameter determined in advance at q. In this case, the parameter modifying block 24 modifies the value of the parameter to q for the voice within the period from n seconds before the good-condition voice to n seconds after the good-condition voice. That is to say, in accordance with the first pattern parameter modification technique, the parameter modifying block 24 sets the parameter modification time range crossing the good-condition voice at a predetermined period of n seconds on both sides of the good-condition voice and uniformly modifies the value of the predetermined parameter to q in the parameter modification time range.

In accordance with the second pattern parameter modification technique, from the beginning, the parameter modifying block 24 sets a parameter modification time range of up to n seconds before the good-condition voice and up to n seconds after the good-condition voice. The parameter modifying block 24 then sets a maximum changed value of a parameter determined in advance at q. In this case, for a voice output at a time position leading ahead of the good-condition voice by x seconds, the parameter modifying block 24 changes the value of a predetermined parameter to (q×x/n). By the same token, for a voice output at a time position lagging behind the good-condition voice by x seconds, the parameter modifying block 24 changes the value of the parameter also to (q×x/n). That is to say, in accordance with the second pattern parameter modification technique, the parameter modifying block 24 sets the parameter modification time range crossing the good-condition voice at a predetermined period of n seconds on both sides of the good-condition voice and modifies the value of the predetermined parameter to (q×x/n) which depends on the time distance of x seconds from the good-condition voice in the parameter modification time range.

In accordance with the third pattern parameter modification technique, from the beginning, the parameter modifying block 24 sets a parameter modification time range of up to n conversations (each also referred to as a voice outputting period) before the good-condition voice and up to n conversations after the good-condition voice. In this case, n is any integer. The parameter modifying block 24 then sets a changed value of a parameter determined in advance at q. In this case, the parameter modifying block 24 modifies the value of the parameter to q for the voice of each of the conversations of n conversations before the good-condition voice and n conversations after the good-condition voice. That is to say, in accordance with the third pattern parameter modification technique, the parameter modifying block 24 sets the parameter modification time range crossing the good-condition voice at a predetermined period of n conversations on both sides of the good-condition voice and uniformly modifies the value of the predetermined parameter to q in the parameter modification time range.

In accordance with the fourth pattern parameter modification technique, from the beginning, the parameter modifying block 24 sets a parameter modification time range of up to n conversations (each also referred to hereafter as a voice outputting period) before the good-condition voice and up to n conversations after the good-condition voice. The parameter modifying block 24 then sets a maximum changed value of a parameter determined in advance at q. In this case, for a voice output in the yth conversation leading ahead of the good-condition voice, the parameter modifying block 24 changes the value of a predetermined parameter to (q×y/n). By the same token, for a voice output in the yth conversation lagging behind the good-condition voice, the parameter modifying block 24 changes the value of the parameter also to (q×y/n). That is to say, in accordance with the fourth pattern parameter modification technique, the parameter modifying block 24 sets the parameter modification time range crossing the good-condition voice at a predetermined period of n conversations on both sides of the good-condition voice and, for a conversation included in the parameter modification time range, the parameter modifying block 24 modifies the value of the predetermined parameter to (q×y/n) depending on y which is the voice outputting sequence number counted from the conversation immediately leading ahead of the good-condition voice or immediately lagging behind the good-condition voice.

### Voice Recognition Processing

Next, the following description explains the flow of the voice recognition processing carried out by the voice recognizing apparatus 1 on mixed voices. In the following description, the voice recognition processing is also referred to as mixed-voice recognition processing.

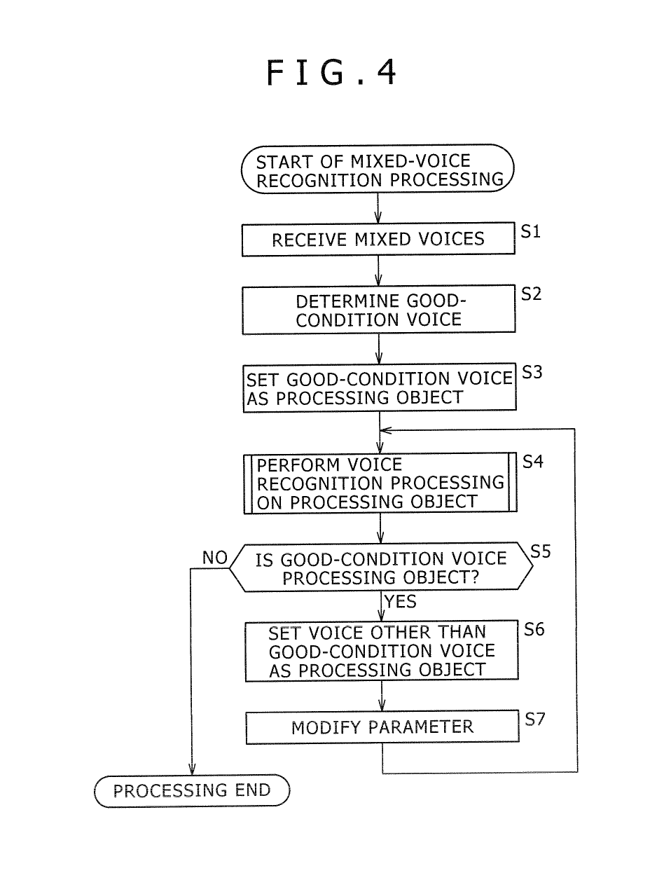

FIG. 4 is a flowchart referred to in the following explanation of a typical flow of the mixed-voice recognition processing.

As shown in the figure, the flowchart begins with a step S1 at which the high-quality-voice determining section 11 receives mixed voices.

Then, at the next step S2, the high-quality-voice determining section 11 determines a good-condition voice included in the mixed voices received by the high-quality-voice determining section 11. To be more specific, the high-quality-voice determining section 11 determines a good-condition voice, which is included in the mixed voices, by adoption of one of the A-pattern, B-pattern and C-pattern techniques explained earlier by referring to FIG. 2. Subsequently, the high-quality-voice determining section 11 supplies the result of the determination to the voice recognizing section 12.

Then, at the next step S3, on the basis of the determination result received from the high-quality-voice determining section 11, the feature-quantity extracting block 21 sets the good-condition voice included in the mixed voices received by the voice recognizing apparatus 1 as a processing object.

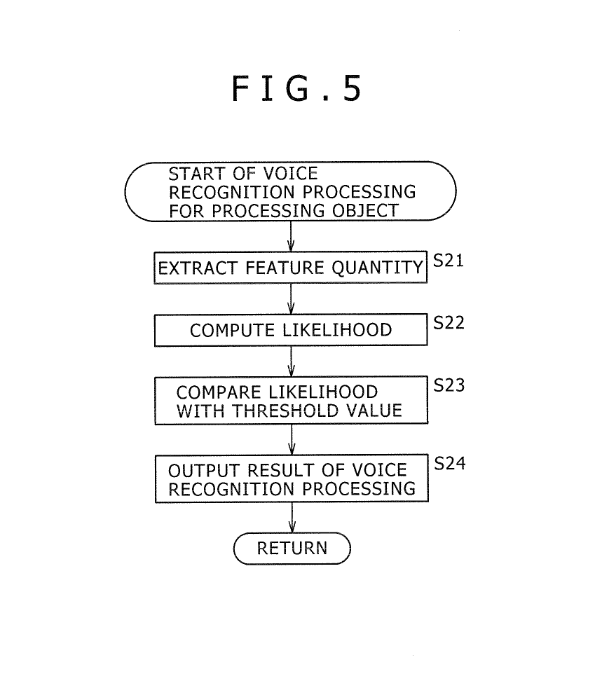

Then, at the next step S4, the voice recognizing section 12 carries out the mixed-voice recognition processing on the processing object. That is to say, if the processing of the step S4 is carried out on the processing object after the step S3, the processing of the step S4 is the mixed-voice recognition processing carried out on the good-condition voice because the processing object is the good-condition voice. If the processing of the step S4 is carried out on the processing object after a step S7 to be described later, on the other hand, the processing of the step S4 is the mixed-voice recognition processing carried out on a voice other than the good-condition voice because the processing object is the voice other than the good-condition voice. A typical example of the voice other than the good-condition voice is a voice leading ahead of the good-condition voice or a voice lagging behind the good-condition voice. In the processing carried out on the processing object at the step S4, the likelihood of the feature quantity of the processing object is computed and compared with a threshold value. It is to be noted that the processing carried out on the processing object at the step S4 will be described in detail by referring to a flowchart shown in FIG. 5.

Then, at the next step S5, the parameter modifying block 24 determines whether or not the good-condition voice is the processing object.

If the processing of the step S4 is carried out on the processing object after the step S3 for example, the good-condition voice is the processing object. In this case, the result of the determination carried out at the step S5 is YES and the flow of the mixed-voice recognition processing goes on to a step S6.

At the step S6, the feature-quantity extracting block 21 sets a voice included in the mixed voices as a voice other than the good-condition voice to serve as the processing object.

Then, at the next step S7, the parameter modifying block 24 changes the value of a parameter used by at least by one of the feature-quantity extracting block 21, the likelihood computing block 22 and the comparison block 23.

Afterwards, the flow of the mixed-voice recognition processing goes back to the step S4. This time, however, the voice other than the good-condition voice serves as the processing object. Thus, the mixed-voice recognition processing is carried out at the step S4 on the processing object, which is the voice other than the good-condition voice, by making use of a parameter whose value has been changed at the step S7. In this case, the result of the determination carried out at the step S5 is NO and the mixed-voice recognition processing is ended completely.

As described above, the mixed-voice recognition processing includes the processing carried out at the step S4. The processing carried out at the step S4 is mixed-voice recognition processing performed on a processing object. The processing carried out at the step S4 is explained in detail as follows.

### Voice Recognition Processing of Processing Object

FIG. 5 is a flowchart referred to in the following explanation of a typical detailed flow of voice recognition processing carried out on a processing object.

As shown in the figure, the flowchart begins with a step S21 at which the feature-quantity extracting block 21 extracts a feature quantity from the processing object. To put it in detail, the feature-quantity extracting block 21 segmentalizes the processing object into a plurality of units determined in advance and sequentially extracts a feature quantity for each of the predetermined units. Subsequently, the feature-quantity extracting block 21 supplies a time-axis series of feature quantities to the likelihood computing block 22.

Then, at the next step S22, the likelihood computing block 22 computes the likelihood of the processing object. That is to say, the likelihood computing block 22 generates a plurality of word model groups each serving as a candidate for the voice recognition result and, for each of the generated word model groups, computes a likelihood that the time-axis series of feature quantities received from the feature-quantity extracting block 21 is observed. Subsequently, the likelihood computing block 22 supplies the likelihoods to the comparison block 23.

Then, at the next step S23, the comparison block 23 compares the likelihood computed by the likelihood computing block 22 for every word model group with a threshold value determined in advance and takes a word model group having a likelihood greater than the predetermined threshold value as the voice recognition result for the processing object.

Then, at the next step S24, the comparison block 23 outputs the voice recognition result for the processing object.

When the comparison block 23 outputs the voice recognition result for the processing object, the voice recognition processing carried out on the processing object is ended. That is to say, the processing carried out at the step S4 of the flowchart shown in FIG. 4 is ended and the flow of the mixed-voice recognition processing goes on to the step S5.

As described above, in accordance with the voice recognizing apparatus, first of all, a good-condition voice included in mixed voices is determined. Then, voice recognition processing is carried out on the good-condition voice. Subsequently, on the basis of the result of the voice recognition processing, a parameter of the voice recognition processing is modified and the voice recognition processing is carried out on a voice other than the good-condition voice. Thus, it is possible to improve the precision of the voice recognition processing carried out on the voice other than the good-condition voice. Accordingly, in the voice recognition processing carried out on the mixed voices, the precision of the voice recognition processing carried out on the voice other than the good-condition voice can be improved. Therefore, as a whole, it is possible to improve the precision of the voice recognition processing.

### Application of the Technology to Programs

The processing series described above can be carried out by making use of hardware or by executing software. If the processing series is carried out by executing software, a program composing the software is installed in a computer. Typically, the computer is a computer embedded in special-purpose hardware or a general-purpose personal computer. The general-purpose personal computer is a personal computer capable of carrying out a variety of functions in accordance with a variety of programs installed in the personal computer.

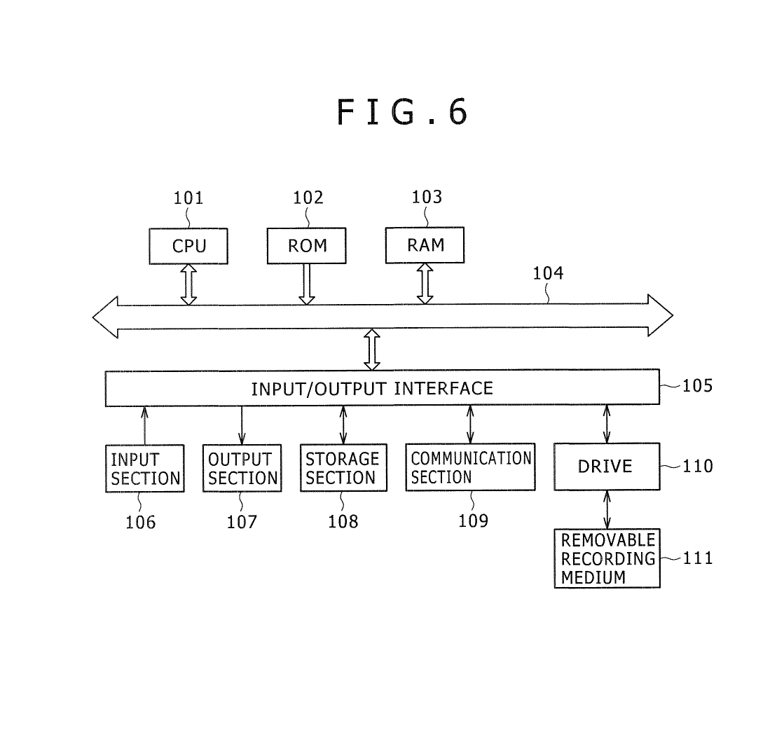

FIG. 6 is a block diagram showing a typical configuration of hardware employed in a computer for carrying out the processing series by execution of programs installed in the computer.

As shown in the figure, the computer includes a CPU (Central Processing Unit) 101, a ROM (Read Only Memory) 102 and a RAM (Random Access Memory) 103 which are connected to each other by a bus 104.

The bus 104 is further connected to an input/output interface 105 which is also connected to an input section 106, an output section 107, a storage section 108, a communication section 109 and a drive 110.

The input section 106 includes a keyboard, a mouse and a microphone whereas the output section 107 includes a display unit and a speaker. The storage section 108 includes a hard disk and a nonvolatile memory. The communication section 109 is typically a network interface. The drive 110 is a section for driving a removable recording medium 111 such as a magnetic disk, an optical disk, a magnetic optical disk or a semiconductor memory.

In the computer configured as described above, for example, the CPU 101 loads a program from the storage section 108 to the RAM 103 by way of the input/output interface 105 and the bus 104. Then, the CPU 101 then executes the program in order to carry out the processing series described above.

The program to be executed by the CPU 101 can be a program recorded on the removable recording medium 111 such as a package recording medium. In this case, the program is installed from the removable recording medium 111 to the storage section 108. As an alternative, the program to be executed by the CPU 101 can also be a program downloaded from a program provider to the storage section 108 through a transmission medium and the communication section 109. The transmission medium can be a radio or wire transmission medium such as a local area network, the Internet or a broadcasting satellite.

In order to install a program from the removable recording medium 111 to the storage section 108, the removable recording medium 111 is mounted on the drive 110. With the removable recording medium 111 mounted on the drive 110, the program can be installed in the storage section 108 by way of the input/output interface 105. In addition, the program is downloaded from a program provider to the storage section 108 through a radio or wire transmission medium and the communication section 109 as follows. The program from the program provider is received by the communication section 109 before being installed in the storage section 108. As another alternative, the program can be stored in advance in the ROM 102 or the storage section 108.

It is to be noted that the program to be executed by the CPU 101 can be a program to be executed to carry out the processing series along the time axis in the order explained before in this specification. As an alternative, the program to be executed by the CPU 101 can be a program to be executed to carry out the processing series in a concurrent processing environment or a program to be executed to carry out the processing series with a proper timing, that is, a program to be executed to carry out the processing series typically when the program is invoked.

Implementations of the present technology are by no means limited to the embodiment described above. That is to say, the present technology can be implemented into a variety of embodiments within a range not deviating from essentials of the present technology.

For example, the present technology can be implemented into a cloud-computing configuration including a plurality of apparatus for carrying out a function by inter-apparatus collaboration through a network in a distributed processing environment.

In addition, the steps of the flowcharts described earlier can be carried out by an apparatus or a plurality of apparatus in a distributed processing environment.

On top of that, if a flowchart step includes a plurality of processes, the processes included in the step can be carried out by an apparatus or a plurality of apparatus in a distributed processing environment.

It is to be noted that the present technology can also be realized into the following implementations:

(1) An information processing apparatus including:

a high-quality-voice determining section configured to determine a voice, which can be determined to have been collected under a good condition, as a good-condition voice included in mixed voices pertaining to a group of voices collected under different conditions; and

a voice recognizing section configured to
carry out voice recognition processing by making use of a predetermined parameter on the good-condition voice determined by the high-quality-voice determining section,
modify the value of the predetermined parameter on the basis of a result of the voice recognition processing carried out on the good-condition voice, and
carry out the voice recognition processing by making use of the predetermined parameter having the modified value on a voice included in the mixed voices as a voice other than the good-condition voice.

(2) The information processing apparatus according to implementation (1) wherein the high-quality-voice determining section segmentalizes the mixed voices into voice outputting periods, computes an S/N ratio for each of the voice outputting periods and determines the good-condition voice for each of the voice outputting periods on the basis of the computed S/N ratios.

(3) The information processing apparatus according to implementation (1) or (2) wherein the high-quality-voice determining section segmentalizes the mixed voices into voice outputting periods, computes an S/N ratio for each of the voice outputting periods and determines the good-condition voice for each of voice outputting persons on the basis of the computed S/N ratios.

(4) The information processing apparatus according to any one of implementations (1) to (3) wherein:

the mixed voices include a plurality of voices each resulting from processing carried out by one of a plurality of audio codecs; and

in a process of determining the good-condition voice, the high-quality-voice determining section determines a voice resulting from processing carried out by an audio codec as a voice having a high quality in comparison with the voices resulting from the processing carried out by each of the other audio codecs.

(5) The information processing apparatus according to any one of implementations (1) to (4) wherein the voice recognizing section includes:

a feature-quantity extracting block configured to extract a feature quantity from a processing object included in the mixed voices;

a likelihood computing block configured to generate a plurality of candidates for a voice recognition processing result for the processing object and compute a likelihood for each of the candidates on the basis of a feature quantity extracted by the feature-quantity extracting block;

a comparison block configured to compare each of the likelihoods each computed by the likelihood computing block for one of the candidates with a predetermined threshold value, to select a voice recognition processing result for the processing object from the candidates on the basis of a result of the comparison and to output the selected voice recognition processing result; and

a parameter modifying block configured to modify a parameter used in at least one of the feature-quantity extracting block, the likelihood computing block and the comparison block as the predetermined parameter on the basis of the voice recognition processing result output by the comparison block when the good-condition voice has been set to serve as the processing object.

(6) The information processing apparatus according to any one of implementations (1) to (5) wherein, if a voice other than the good-condition voice has been set to serve as the processing object, the parameter modifying block modifies a prior probability, which is used by the likelihood computing block in computation of a likelihood, as the predetermined parameter for a candidate including a word included in a voice recognition processing result for the good-condition voice.

(7) The information processing apparatus according to any one of implementations (1) to (6) wherein, if a voice other than the good-condition voice has been set to serve as the processing object, the parameter modifying block modifies the threshold value, which is used in the comparison block, as the predetermined parameter.

(8) The information processing apparatus according to any one of implementations (1) to (7) wherein, if a voice other than the good-condition voice has been set to serve as the processing object, the parameter modifying block modifies a prior probability, which is used by the likelihood computing block in computation of a likelihood, as the predetermined parameter for a candidate including a related word of a word included in a voice recognition processing result for the good-condition voice.

(9) The information processing apparatus according to any one of implementations (1) to (8) wherein, if a voice other than the good-condition voice has been set to serve as the processing object, the parameter modifying block modifies a frequency analysis technique, which is adopted in the feature-quantity extracting block to extract a feature quantity, as the predetermined parameter.

(10) The information processing apparatus according to any one of implementations (1) to (9) wherein, if a voice other than the good-condition voice has been set to serve as the processing object, the parameter modifying block modifies the type of a feature quantity, which is extracted by the feature-quantity extracting block, as the predetermined parameter.

(11) The information processing apparatus according to any one of implementations (1) to (10) wherein, if a voice other than the good-condition voice has been set serve as the processing object, the parameter modifying block modifies the number of candidates, which are used in the likelihood computing block, as the predetermined parameter.

(12) The information processing apparatus according to any one of implementations (1) to (11) wherein the parameter modifying block sets a predetermined number of time units before and after the good-condition voice to serve as a modification time range for the predetermined parameter and uniformly modifies the value of the predetermined parameter for a voice output at a time included in the modification time range.

(13) The information processing apparatus according to any one of implementations (1) to (12) wherein the parameter modifying block sets a predetermined number of time units before and after the good-condition voice to serve as a modification time range for the predetermined parameter and modifies the value of the predetermined parameter for a voice output at a time included in the modification time range in accordance with a time distance from the good-condition voice to the voice output at a time included in the modification time range.

(14) The information processing apparatus according to any one of implementations (1) to (13) wherein the parameter modifying block sets a predetermined number of voice outputting periods before and after the good-condition voice to serve as a modification time range for the predetermined parameter and uniformly modifies the value of the predetermined parameter for a voice output at a time included in the modification time range.

(15) The information processing apparatus according to any one of implementations (1) to (14) wherein:

the parameter modifying block sets a predetermined number of voice outputting periods before and after the good-condition voice to serve as a modification time range for the predetermined parameter;

a sequence number counted from the voice outputting period immediately before the good-condition voice is assigned to each of the voice outputting periods before the good-condition voice whereas a sequence number counted from the voice outputting period immediately after the good-condition voice is assigned to each of the voice outputting periods after the good-condition voice; and

for a voice outputting period included in the modification time range, the parameter modifying block modifies the value of the predetermined parameter in accordance with the sequence number assigned to the voice outputting period.

The present technology can be applied to a voice recognizing apparatus taking mixed voices as an object of processing.

The present disclosure contains subject matter related to that disclosed in Japanese Priority Patent Application JP 2012-105948 filed in the Japan Patent Office on May 7, 2012, the entire content of which is hereby incorporated by reference.

It should be understood by those skilled in the art that various modifications, combinations, sub-combinations and alternations may occur depending on design requirements and other factors insofar as they are within the scope of the appended claims or the equivalent thereof.

What is claimed is:

1. An information processing apparatus comprising:
a high-quality-voice determining section configured to determine a voice, which can be determined to have been collected under a good condition, as a good-condition voice included in mixed voices pertaining to a group of voices collected under different conditions; and
a voice recognizing section configured to
carry out voice recognition processing by making use of a predetermined parameter on said good-condition voice determined by said high-quality-voice determining section,
modify the value of said predetermined parameter on the basis of a result of said voice recognition processing carried out on said good-condition voice, and
carry out said voice recognition processing by making use of said predetermined parameter having said modified value on a voice included in said mixed voices as a voice other than said good-condition voice.

2. The information processing apparatus according to claim 1 wherein said high-quality-voice determining section segmentalizes said mixed voices into voice outputting periods, computes a signal to noise ratio each of said voice outputting periods and determines said good-condition voice for each of said voice outputting periods on the basis of said computed signal to noise ratios.

3. The information processing apparatus according to claim 1 wherein said high-quality-voice determining section segmentalizes said mixed voices into voice outputting periods, computes a signal to noise ratio for each of said voice outputting periods and determines said good-condition voice for each of voice outputting persons on the basis of said computed signal to noise ratios.

4. The information processing apparatus according to claim 1 wherein:
said mixed voices include a plurality of voices each resulting from processing carried out by one of a plurality of audio codecs; and
in a process of determining said good-condition voice, said high-quality-voice determining section determines a voice resulting from processing carried out by an audio codec as a voice having a high quality in comparison with said voices resulting from said processing carried out by each of said other audio codecs.

5. The information processing apparatus according to claim 1 wherein said voice recognizing section includes:
a feature-quantity extracting block configured to extract a feature quantity from a processing object included in said mixed voices;
a likelihood computing block configured to generate a plurality of candidates for a voice recognition processing result for said processing object and compute a likelihood for each of said candidates on the basis of a feature quantity extracted by said feature-quantity extracting block;
a comparison block configured to compare each of said likelihoods each computed by said likelihood computing block for one of said candidates with a predetermined threshold value, to select a voice recognition processing result for said processing object from said candidates on the basis of a result of said comparison and to output said selected voice recognition processing result; and
a parameter modifying block configured to modify a parameter used in at least one of said feature-quantity extracting block, said likelihood computing block and said comparison block as said predetermined parameter on the basis of said voice recognition processing result output by said comparison block when said good-condition voice has been set to serve as said processing object.

6. The information processing apparatus according to claim 5 wherein, if a voice other than said good-condition voice has been set to serve as said processing object, said parameter modifying block modifies a prior probability, which is used by said likelihood computing block in computation of a likelihood, as said predetermined parameter for a candidate including a word included in a voice recognition processing result for said good-condition voice.

7. The information processing apparatus according to claim 5 wherein, if a voice other than said good-condition voice has been set to serve as said processing object, said parameter modifying block modifies said threshold value, which is used in said comparison block, as said predetermined parameter.

8. The information processing apparatus according to claim 5 wherein, if a voice other than said good-condition voice has been set to serve as said processing object, said parameter modifying block modifies a prior probability, which is used by said likelihood computing block in computation of a likelihood, as said predetermined parameter for a candidate including a related word of a word included in a voice recognition processing result for said good-condition voice.

9. The information processing apparatus according to claim 5 wherein, if a voice other than said good-condition voice has been set to serve as said processing object, said parameter modifying block modifies a frequency analysis technique, which is adopted in said feature-quantity extracting block to extract a feature quantity, as said predetermined parameter.

10. The information processing apparatus according to claim 5 wherein, if a voice other than said good-condition voice has been set to serve as said processing object, said parameter modifying block modifies the type of a feature quantity, which is extracted by said feature-quantity extracting block, as said predetermined parameter.

11. The information processing apparatus according to claim 5 wherein, if a voice other than said good-condition voice has been set to serve as said processing object, said parameter modifying block modifies the number of candidates, which are used in said likelihood computing block, as said predetermined parameter.

12. The information processing apparatus according to claim 5 wherein said parameter modifying block sets a predetermined number of time units before and after said good-condition voice to serve as a modification time range for said predetermined parameter and uniformly modifies the value of said predetermined parameter for a voice output at a time included in said modification time range.

13. The information processing apparatus according to claim 5 wherein said parameter modifying block sets a predetermined number of time units before and after said good-condition voice to serve as a modification time range for said predetermined parameter and modifies the value of said predetermined parameter for a voice output at a time included in said modification time range in accordance with a time distance from said good-condition voice to said voice output at a time included in said modification time range.

14. The information processing apparatus according to claim 5 wherein said parameter modifying block sets a predetermined number of voice outputting periods before and after said good-condition voice to serve as a modification time range for said predetermined parameter and uniformly modifies the value of said predetermined parameter for a voice output at a time included in said modification time range.

15. The information processing apparatus according to claim 5 wherein:
said parameter modifying block sets a predetermined number of voice outputting periods before and after said good-condition voice to serve as a modification time range for said predetermined parameter;
a sequence number counted from said voice outputting period immediately before said good-condition voice is assigned to each of said voice outputting periods before said good-condition voice whereas a sequence number counted from said voice outputting period immediately after said good-condition voice is assigned to each of said voice outputting periods after said good-condition voice; and
for a voice outputting period included in said modification time range, said parameter modifying block modifies the value of said predetermined parameter in accordance with said sequence number assigned to said voice outputting period.

16. An information processing method to be adopted by an information processing apparatus to serve as a method comprising:
determining a voice, which can be determined to have been collected under a good condition, as a good-condition voice included in mixed voices pertaining to a group of voices collected under different conditions;
carrying out voice recognition processing by making use of a predetermined parameter on said determined good-condition voice;
modifying the value of said predetermined parameter on the basis of a result of said voice recognition processing carried out on said good-condition voice; and
carrying out said voice recognition processing by making use of said predetermined parameter having said modified value on a voice included in said mixed voices as a voice other than said good-condition voice.

17. An information processing program to be executed by a computer in order to function as:
a high-quality-voice determining section configured to determine a voice, which can be determined to have been collected under a good condition, as a good-condition voice included in mixed voices pertaining to a group of voices collected under different conditions; and
a voice recognizing section configured to
carry out voice recognition processing by making use of a predetermined parameter on said good-condition voice determined by said high-quality-voice determining section,
modify the value of said predetermined parameter on the basis of a result of said voice recognition processing carried out on said good-condition voice, and
carry out said voice recognition processing by making use of said predetermined parameter having said modified value on a voice included in said mixed voices as a voice other than said good-condition voice.
